(19) United States
(12) Patent Application Publication
(10) Pub. No.: US 2019/0141003 A1
(43) Pub. Date: May 9, 2019

(54) Sending Safety-Check Prompts

(71) Applicant: Facebook, Inc., Menlo Park, CA (US)

(72) Inventors: Peter Michael Cottle, Palo Alto, CA (US); Emily M. Tucker, Berkeley, CA (US); Matthew Ethan Warshauer, San Francisco, CA (US); Sriya Santhanam, Mountain View, CA (US)

(21) Appl. No.: 15/807,515

(22) Filed: Nov. 8, 2017

(51) Int. Cl. H04L 12/58; G06Q 50/00; H04M 1/725; H04L 29/08; H04W 4/02

(52) U.S. Cl. CPC H04L 51/32; G06Q 50/01; H04M 1/72538; H04W 4/023; H04L 67/22; H04M 1/72552; H04L 51/20

(57) ABSTRACT

In one embodiment, a method includes determining that an emergency event has occurred. The method also includes determining a geographic area affected by the emergency event. The method also includes determining that a user has entered the geographic area within a pre-determined amount of time after the occurrence of the emergency event. The method also includes sending a prompt to the user to indicate whether the user is safe. The method also includes receiving from the user a response indicating whether the user is safe.

### TECHNICAL FIELD

This disclosure generally relates to sending notifications during and after emergencies.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a GPS receiver, compass, gyroscope, or accelerometer. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

Natural or man-made disasters often cause fear and uncertainty. During an emergency in which a disaster is occurring or has just occurred, users of an online social network may wish to check on their friends and loved ones who may be affected by the disaster. Users affected by the disaster may wish to let others know whether they are safe. In particular embodiments, the social-networking system may send a safety-check prompt to a user during an emergency. The safety-check prompt may request the user to specify whether she is safe, not safe, or out of the affected area of the emergency. As an example and not by way of limitation, an explosion in Manhattan, a borough in New York City, may cause the social-networking system to send safety-check prompts to users living in Manhattan. The safety-check prompt may state: “Are you okay? It looks like you're in the area affected by the explosion. Let your friends know you're safe.” The user may then select whether or not she is safe, or if she is not in the area.

Different emergencies have different impacts and durations. Some emergencies affect many thousands of people for several hours or days (e.g., floods, hurricanes). Some emergencies affect many thousands of people for a short period of time (e.g., earthquakes). Some emergencies affect few people for a long time (e.g., a hostage situation). Some emergencies affect relatively few people for a short amount of time (e.g., a mass shooting, an explosion). It is desirable for the social-networking system to send safety-check prompts to the relevant users. The social-networking system should not send safety-check prompts to too many or too few users. To send safety-check prompts to the relevant users, the social-networking system may identify features of the emergency event and determine recipients based on the emergency features. These features may include the type of emergency, the geographic region of the emergency, the expected duration of the emergency, the severity of the emergency, or any other suitable feature. Once it has made these determinations, the social-networking system may determine whether to establish a city-wide safety check, a hyperlocal safety check, or a sub-city safety check. A city-wide safety check may call for safety-check prompts to be sent to users throughout an entire city or region. A hyperlocal safety check may call for safety-check prompts to be sent to users in a highly localized geographic region. The social-networking system may send a hyperlocal safety check only once to an initial set of users within a certain area, and may be capped at a particular number of users. Users of the online social network may share the hyperlocal safety check with other users, but the social-networking system may not send the hyperlocal safety check to additional users after it has sent the hyperlocal safety check to the initial set of users. A sub-city safety check may call for safety-check prompts to be sent to sub-sections of cities. In a sub-city safety check situation, the social-networking system may designate a particular geographic area as a zone of interest for a specified duration of time, and, for the specified duration of time, the social-networking system may send a safety-check prompt to each user who enters the zone of interest. There may be no maximum number of users that may receive the sub-city safety check. The social-networking system may send a sub-city safety check prompt to each user who enters the zone of interest within a particular amount of time. Both the size of the zone of interest and the amount of time the social-networking system sends sub-city safety-check prompts may vary depending on the amount of user engagement, characteristics of the emergency, or any other suitable reason.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example user interface of a safety check for an example emergency.

FIG. 2 illustrates an example notification interface comprising a safety-check prompt notification.

FIG. 3 illustrates an example visualization for determining a zone of interest associated with an emergency event.

FIG. 4 illustrates an example visualization for determining to send a particular type of safety-check prompt.

FIG. 5 illustrates an example method for determining a zone of interest and determining to send safety-check prompts to users within the zone of interest.

FIG. 6 illustrates an example method for determining to send a safety-check prompt to a user.

FIG. 7 illustrates an example network environment associated with a social-networking system.

FIG. 8 illustrates an example social graph.

FIG. 9 illustrates an example computer system.

### DESCRIPTION OF EXAMPLE EMBODIMENTS

Natural or man-made disasters often cause fear and uncertainty. During an emergency in which a disaster is occurring or has just occurred, users of an online social network may wish to check on their friends and loved ones who may be affected by the disaster. Users affected by the disaster may wish to let others know whether they are safe. In particular embodiments, the social-networking system may send a safety-check prompt to a user during an emergency. The safety-check prompt may request the user to specify whether she is safe, not safe, or out of the affected area of the emergency. As an example and not by way of limitation, an explosion in Manhattan, a borough in New York City, may cause the social-networking system to send safety-check prompts to users living in Manhattan. The safety-check prompt may state: “Are you okay? It looks like you're in the area affected by the explosion. Let your friends know you're safe.” The user may then select whether she is safe, or whether she is out of the area. In response to the user's response to the safety-check prompt, the social-networking system may send a message to the user's friends indicating whether the user is safe. The message may be sent via a newsfeed or any other suitable method. As an example and not by way of limitation, when a user logs onto the online social network, she may see a content object that says “Heather, Derek, and 23 others marked themselves safe during the Explosion in Manhattan.

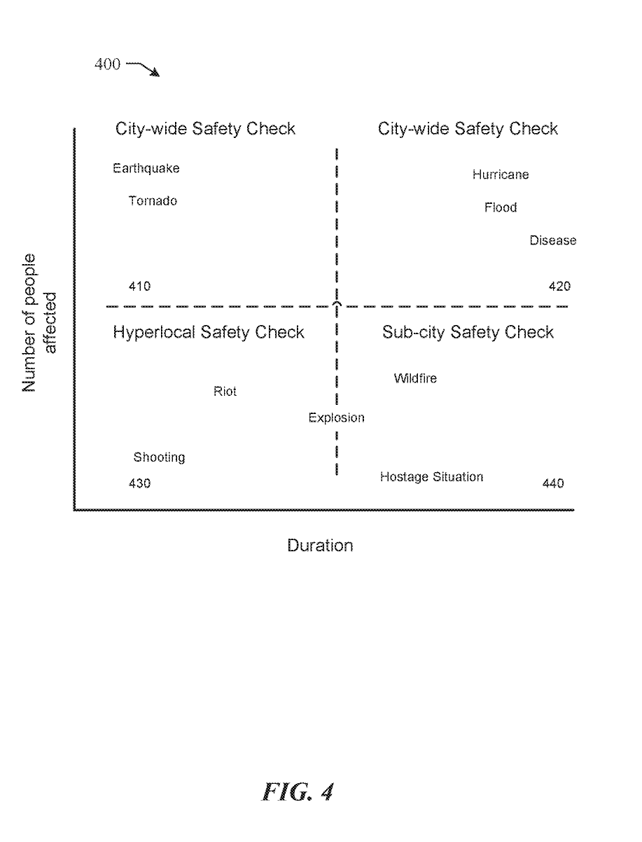

Different emergencies have different impacts and durations. Some emergencies affect many thousands of people for several hours or days (e.g., floods, hurricanes). Some emergencies affect many thousands of people for a short period of time (e.g., earthquakes). Some emergencies affect few people for a long time (e.g., a hostage situation). And some emergencies affect relatively few people for a short amount of time (e.g., a mass shooting, an explosion). See FIG. 4 for an illustration of this concept. It is desirable for the social-networking system to send safety-check prompts to the relevant users. The social-networking system should not send safety-check prompts to too many or too few users. For example, if seven people are injured by a motorist in Chicago, it is probably not appropriate to send a safety-check prompt to all of Chicago's 2.7 million denizens. On the other hand, if the entire city of Houston is at risk of being flooded during a hurricane, it may be appropriate to send a safety-check prompt to all users who are in Houston during the flood watch. To send safety-check prompts to the relevant users, the social-networking system may identify features of the emergency event and determine recipients based on the emergency features. These features may include the type of emergency, the geographic region of the emergency, the expected duration of the emergency, the severity of the emergency, or any other suitable feature. Once it has made these determinations, the social-networking system may determine whether to establish a city-wide safety check, a hyperlocal safety check, or a sub-city safety check. A city-wide safety check may call for safety-check prompts to be sent to users throughout an entire city or region. The social-networking system may send a hyperlocal safety check only once to an initial set of users within a certain area, and may be capped at a particular number of users. Users of the online social network may share the hyperlocal safety check with other users, but the social-networking system may not send the hyperlocal safety check to additional users after it has sent the hyperlocal safety check to the initial set of users. A sub-city safety check may call for safety-check prompts to be sent to sub-sections of cities. In a sub-city safety check situation, the social-networking system may designate a particular geographic area as a zone of interest for a specified duration of time, and, for the specified duration of time, the social-networking system may send a safety-check prompt to each user who enters the zone of interest. There may be no maximum number of users that may receive the sub-city safety check. The social-networking system may send a sub-city safety check prompt to each user who enters the zone of interest within a particular amount of time. Both the size of the zone of interest and the amount of time the social-networking system sends sub-city safety-check prompts may vary depending on the amount of user engagement, characteristics of the emergency, or any other suitable reason.

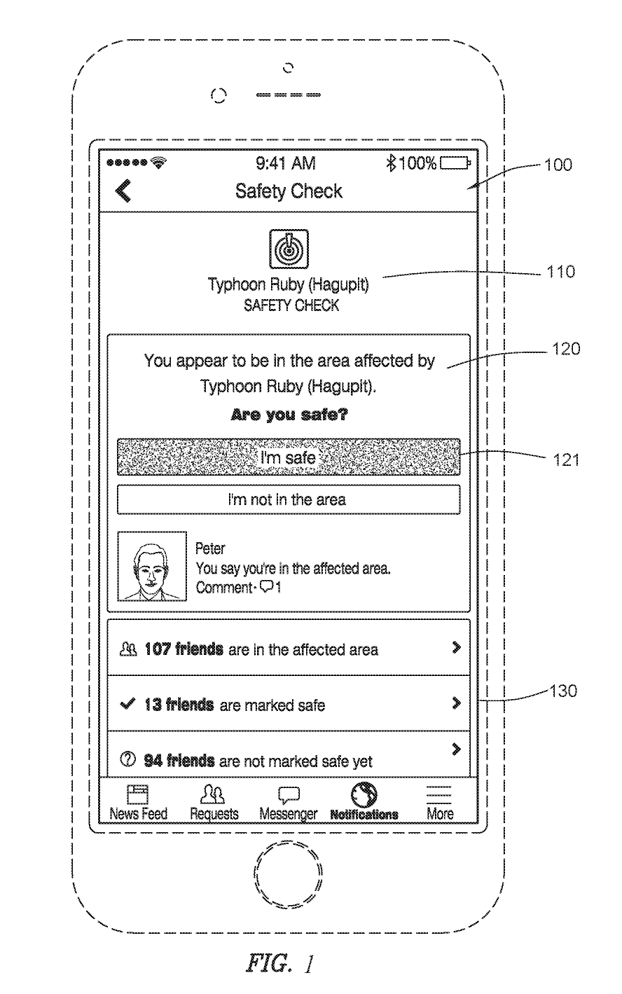

FIG. 1 illustrates an example user interface 100 of a safety check for an example emergency. User interface 100 may be displayed once a user opens a notification that comprises the safety-check prompt. User interface 100 may comprise an emergency panel 110, safety-check panel 120, and friend-status panel 130. Emergency panel 110 may display information about the particular emergency related to the safety-check prompt. As an example and not by way of limitation, emergency panel 110 may state that Typhoon Ruby is currently affecting an area that the social-networking system may associate with the user, either because the GPS unit in the user's client device indicates that the user is located in the affected geographic area, or the user specified that she is currently living in an area affected by the emergency event. Emergency panel 110 may comprise additional information, such as statistics or headlines related to the emergency event, as well as any directions safety officials wish to communicate to the public. As an example and not by way of limitation, emergency panel 110 may comprise text that states “130 mph winds. Officials advise everyone to stay indoors.” Safety-check panel 120 may comprise text and selectable icons 121 whereby the user may designate his safety status. As an example and not by way of limitation, safety-check panel 120 may comprise text that states: “You appear to be in the area affected by Typhoon Ruby. Are you safe?” Safety-check panel 120 may further comprise selectable icons 121 that state, “I'm safe,” “I'm not in the area,” or “I'm not safe.” If the user selects the “I'm not safe” icon, this information may be given to emergency personnel, who may then contact the user or send aid to the user. If the user selects the “I'm safe” icon, the social-networking system may display an option for the user to post a status update indicating this information, so that her friends and family know she is safe. Friend-status panel 130 may display the status of the user's friends on the online social network.

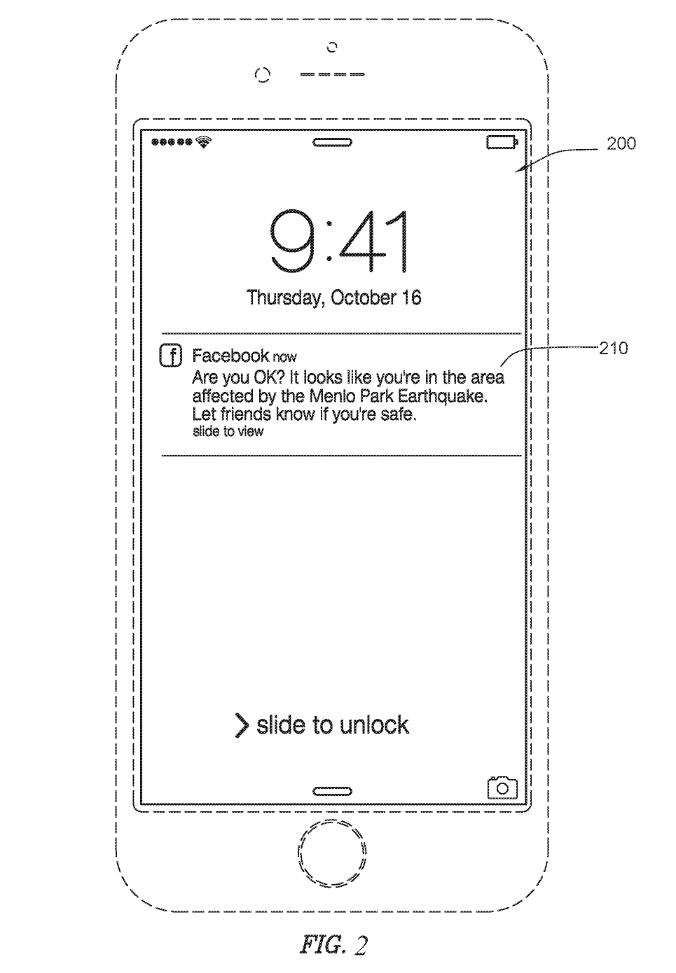

FIG. 2 illustrates an example notification interface 200 comprising a safety-check prompt notification 210. In particular embodiments, when the social-networking system determines to send a safety-check prompt to a user, it may send the safety-check prompt in the form of a notification (e.g., safety-check prompt notification 210) on a lock screen or notification interface 200 of the client system of the user. When the user receives the safety-check prompt notification, the user may interact with the notification by swiping or tapping on it or otherwise selecting it or the user may ignore the notification. Although this disclosure contemplates sending a safety-check prompt notification to a user in a particular manner, this disclosure contemplates sending a safety-check prompt notification to a user in any particular manner.

As mentioned above, the social-networking system may need to make a few determinations to ensure that the safety-check prompts are delivered to the appropriate users. Those determinations include: (1) the geographic area associated with the emergency event; (2) the type of emergency event; and (3) the expected duration of the emergency event. The expected duration of the emergency event may be related to the type of emergency. Thus, in particular embodiments, the social-networking system may only make two determinations: the geographic area of the event and the type of emergency.

In particular embodiments, the social-networking system may determine that an emergency event has occurred. The emergency event may be any type of emergency, natural or manmade, that causes public concern or fear. The emergency may be life-threatening or may simply cause apprehension among the public. Examples of natural emergencies that the social-networking system may identify are earthquakes, tornados, floods, hurricanes, wildfires, or any other suitable type of emergency. Examples of manmade emergencies may include shootings, bombings, plane or bus hijackings, motor-vehicle related terror attacks, or other terrorist activities. Other man-made emergencies include accidental disasters, such as gas line explosions, oil leaks, gas leaks, nuclear reactor meltdowns, the release of a pathogen into the air or water supply, or any other type of emergency. In particular embodiments, the emergency need not threaten harm to life or limb; the emergency may be a cyber-attack, an economic disaster, a computer-security threat, or any other type of suitable emergency. As an example and not by way of limitation, an emergency that the social-networking system may identify may be a widespread identity theft of users' names, social security numbers, or financial information. Although this disclosure describes particular emergencies, this disclosure contemplates any suitable emergencies.

In particular embodiments, the social-networking system may monitor an alert feed that may be maintained either by the social-networking system or by a third-party. The alert feed may comprise one or more items that correspond to a disaster or other event worthy of public concern. Examples of items on an alert feed may include a fire in Boston, Massachusetts, a gas line explosion in Plano, Tex., a shooting in Orlando, Fla., a typhoon in the Philippines, and a bomb explosion in Baghdad, Iraq. The alert feed may also include less serious events, such as power outages and flight delays. In particular embodiments, the social-networking system may crowdsource the emergency event feed. This may be understood to mean that users of the online social network may post or submit content related to an emergency to the online social network. In particular embodiments, a user may fill out a disaster-notice form to indicate that a disaster has occurred or is currently occurring in the user's area. In particular embodiments, a user may simply post content as a status update that is related to an emergency, and the social-networking system may determine that it is related to a particular emergency based on natural language processing. If a threshold number of users post or submit content related to a particular emergency, the social-networking system may recognize the emergency as warranting a safety-check prompt, and may proceed with the steps of the method described herein. Although this disclosure describes monitoring an alert feed in a particular manner, this disclosure contemplates monitoring an alert feed in any suitable manner.

In particular embodiments, the social-networking system may identify one or more qualifying emergencies from a list of items on an alert feed. An item on an alert feed may need to meet one or more emergency metrics to become a qualifying event. The purpose of identifying a qualifying event may be to ensure the social-networking system sends safety-checks related to events that most would consider a real emergency, and not merely an inconvenience. As an example and not by way of limitation, if a power outage causes several flight delays, this event may appear on an alert feed. But these flight delays may be merely annoying rather than fear-inducing. In such a situation, it may be undesirable for the social-networking system to send a safety-check about the flight delays to users, even though many users may post status updates that are related to the flight delays. Thus, an item on an alert feed may need to meet particular emergency metrics in order to become a qualifying emergency. Examples of emergency metrics may include: the event must impact at least a threshold number of users (e.g., a two-car collision on a highway may not meet the requirements); the event must cause public fear or apprehension (e.g., a power outage is an inconvenience, but may not induce fear or be particularly threatening); or the item in an alert feed must include at least one trigger word (e.g., “fire,” “shooting,” “earthquake,” “bomb,” “riot,” etc.). In particular embodiments, the social-networking system may upgrade a non-qualifying event to a qualifying emergency based on events related to the non-qualifying event. As an example and not by way of limitation, a power outage may be a non-qualifying event because it is not life threatening or fear-inducing, but if the power outage leads to looting and rioting, the social-networking system may upgrade the power outage to a qualifying event, because of the looting and rioting. In particular embodiments, the social-networking system may filter out particular items on an alert feed based on language processing (e.g., keyword matching). As an example and not by way of limitation, power outages, flight delays, and traffic jams may be automatically filtered from an alert feed. Although this disclosure describes identifying a qualifying emergency event in a particular manner, this disclosure contemplates identifying qualifying emergency events in any suitable manner.

In particular embodiments, the emergency event may not be associated with a particular geographic location, but rather may be associated with some other criteria. Such criteria may include membership in a particular organization (e.g., the CHURCH OF SCIENTOLOGY, the REPUBLICAN PARTY), subscription to a particular service (e.g., GMAIL, MORGAN STANLEY WEALTH MANAGEMENT), ownership of a particular product (e.g., an IPHONE, a TOYOTA PRIUS) or any other suitable criteria. As an example and not by way of limitation, an emergency event may be a cyber-attack on hundreds of thousands of people who have a WINDOWS operating system. The cyber-attack may have infiltrated these people's computers and gathered private financial information about them. Within a relatively short amount of time after the attack (e.g., 1 day), 2,000 users may have posted content on the online social network related to the cyber-attack. Of those 2,000 users, 1,200 may be WINDOWS users. The posts by the 1,200 users may satisfy the requirement that a threshold percentage of users associated with the emergency event have posted content related to the emergency event. In response, social-networking system 160 may send, to a smaller subset of those 1,200 users (e.g., 100 users), a safety-check prompt that says, “Have you been hacked? It looks like you're running WINDOWS, which has been the victim of a cyber-attack. Let friends know if you've been hacked.” FIG. 4 illustrates an example notification similar to the notifications described here. Each user who receives the safety-check prompt may have the option to either respond to the safety-check prompt, or to ignore it. Although this disclosure describes sending a safety-check prompt to users in a particular manner, this disclosure contemplates sending a safety-check prompt to users in any suitable manner.

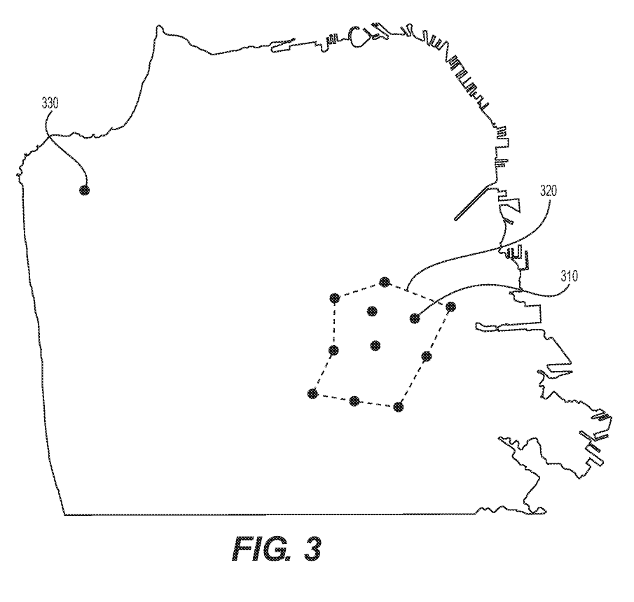

FIG. 3 illustrates an example visualization for determining a zone of interest associated with an emergency event. In particular embodiments, the social-networking system may determine a geographic area affected by the emergency event. The social-networking system may do this in any suitable manner, and the manner illustrated in FIG. 3 is an example only. FIG. 3 illustrates an example map of San Francisco, Calif. The map includes several points 310 and a perimeter 320. Points 310 correspond to locations where a user of the online social network has posted first-hand content related to the emergency event. First-hand content may be content that suggests that the user has personally experienced the event. First-hand content may include a live video, photos, text, a pre-recorded video, or any other suitable content. It may be important to distinguish between first-hand contend and second-hand content because the social-networking system may use the first-hand content to establish perimeter 320, which may set the area for a zone of interest associated with the emergency. As an example and not by way of limitation, the social-networking system may determine that a riot is happening in San Francisco and identify it as an emergency event. The social-networking system may next determine the geographic area affected by the emergency event, which may also be referred to herein as the zone of interest. In particular embodiments, the geographic area affected by the emergency event may be determined by generating a perimeter for the emergency event. The perimeter may be generated by determining locations for posts of first-hand content of the emergency. To determine these locations, the social-networking system may (1) determine whether a post contains first-hand content of the event, (2) determine whether the post was made at a perimeter location, and (3) exclude the location if it is an outlier.

To determine whether a post contains first-hand content of an emergency event, the social-networking system may consider a variety of factors, including whether the post contains a photo, video, or live video, whether the post contains a news article, whether the post has a geographic location that is far from other posts about the emergency event, and the language in the post itself. If the post contains a photo, video, or live video, this may be an indication that the post is first-hand content, because a user who is experiencing the event is more likely to post a photo, video, and especially a live video of the event. A user who is not experiencing the event first-hand may be more likely to post a news article or to merely input text about the event, such as “thoughts and prayers go out to my friends in San Francisco” for an emergency that is occurring in San Francisco. The social-networking system may assign a score to each post that represents the likelihood that the post contains first-hand content of the event. The score may be based on the factors discussed above and may be calculated using any suitable method, including a machine learning model that takes as input the location of the post, the factors listed above, and any other suitable factor. The machine learning model may output the score for the post. If the score is above a threshold, the location of the post may be plotted on a map, as illustrated by points 310 in FIG. 3. To determine whether the post was made at a perimeter location, the social-networking system may compare the latitude and longitude coordinates of the location associated with the post against the latitude and longitude coordinates of other posts that contain first-hand content of the emergency event. If the post has the most extreme latitude or longitude coordinate of the posts that contain first-hand content of the emergency event, it may be considered to have been made at a perimeter location.

Finally, the social-networking system may need to exclude outlier posts. Outlier posts may be posts made at a location that is beyond a threshold distance from a concentration of posts. In particular embodiments, this step may be handled at the first-hand content stage (i.e., when the social-networking system determines if a post contains first-hand content), because a post made far from the concentration of posts is less likely to contain first-hand content. For example, for a fire on First Street, the social-networking system may identify a concentration of posts located around First Street. If a post came from a location on Tenth Street (ten blocks away from First Street), it is unlikely that this post contains first-hand content. If, however, the post is classified as first-hand content, the social-networking system may still remove this post if it originated from a location that is beyond a threshold distance from a concentration of posts. This concept is illustrated by outlier point 330 in FIG. 3. It may be undesirable to include this point as a perimeter location and then extend perimeter 320 out to outlier point 330, because the expanded perimeter may include numerous users who are not affected by the emergency event. In particular embodiments, this step may be omitted and a perimeter may be drawn that extends to the outlier points. In particular embodiments the social-networking system may adjust the zone of interest at regular intervals. For example, the emergency may be a wildfire that may be spreading to several nearby neighborhoods. The social-networking system may perform the above analysis every hour or every thirty minutes. Based on the new location points that correspond to posts containing first-hand content, the social-networking system may update the perimeter 320 and thus update the zone of interest. The zone of interest may expand or contract based on the incoming posts. In particular embodiments, the zone of interest may be established by a third-party entity and the social-networking system may simply accept the third-party entity's assessment of the affected area. As an example and not by way of limitation, the local police department may specify an area of three blocks in every direction around an emergency to be high risk. In response, the social-networking system may establish this area as the zone of interest. Although this disclosure describes determining a geographic area affected by the emergency event in a particular manner, this disclosure contemplates determining a geographic area affected by the emergency event in any suitable manner.

FIG. 4 illustrates an example visualization for determining to send a particular type of safety-check prompt. In addition to determining the geographic area affected by the emergency event, the social-networking system may need to determine the type of safe-check prompt to send. The social-networking system may send a city-wide safety check, a hyperlocal safety check, or a sub-city safety check. A city-wide safety check may call for safety-check prompts to be sent to users throughout an entire city or region. A hyperlocal safety check may call for safety-check prompts to be sent to users in a highly localized geographic region. The social-networking system may send a hyperlocal safety check only once to an initial set of users within a certain area, and may be capped at a particular number of users. Users of the online social network may share the hyperlocal safety check with other users, but the social-networking system may not send the hyperlocal safety check to additional users after it has sent the hyperlocal safety check to the initial set of users. A sub-city safety check may call for safety-check prompts to be sent to sub-sections of cities. In a sub-city safety check situation, the social-networking system may designate a particular geographic area as a zone of interest for a specified duration of time, and, for the specified duration of time, the social-networking system may send a safety-check prompt to each user who enters the zone of interest. There may be no maximum number of users that may receive the sub-city safety check. The social-networking system may send a sub-city safety check prompt to each user who enters the zone of interest within a particular amount of time. Both the size of the zone of interest and the amount of time the social-networking system sends sub-city safety-check prompts may vary depending on the amount of user engagement, characteristics of the emergency, or any other suitable reason.

Quadrants 410, 420, 430 and 440 in FIG. 4 each correspond to a different type of safety-check prompt. The social-networking system may determine the type of safety-check based on which quadrant the emergency falls into. The x-axis of graph 400 represents the duration of the emergency event. The y-axis of graph 400 represents the number of people affected by the emergency. Inside the graph are several example emergencies. They have been placed on the graph as examples only and may fall in different quadrants based on individual circumstances. The social-networking system may nevertheless establish general quadrants for each emergency. As an example and not by way of limitation, hurricanes can affect hundreds of thousands of people and can last for several days. Thus, hurricanes are likely to fall into quadrant 420 and may qualify to receive a city-wide safety check. Events that fall into quadrant 420 affect lots of people and last for a relatively long time. Thus, the city-wide safety check may additionally have a time component, wherein users to enter the affected city may receive safety-check prompts for a pre-determined amount of time after the emergency event has been established. In this case, the pre-determined amount of time may be two days, for example. As another example and not by way of limitation, an earthquake also affects hundreds of thousands of people but only lasts for a few seconds or minutes. Thus, it may fall into quadrant 410 and may qualify users to receive city-wide safety checks. However, in particular embodiments, after an earthquake occurs, the danger in the area is not necessarily ongoing. An exception may be if the earthquake was severe, then there are other risks, such as collapsing buildings, gas line explosions, and other associated dangers. However, in general an earthquake may be a single isolated incident that lasts only a brief amount of time. In this case the pre-determined amount of time may be relatively short, such as thirty minutes.

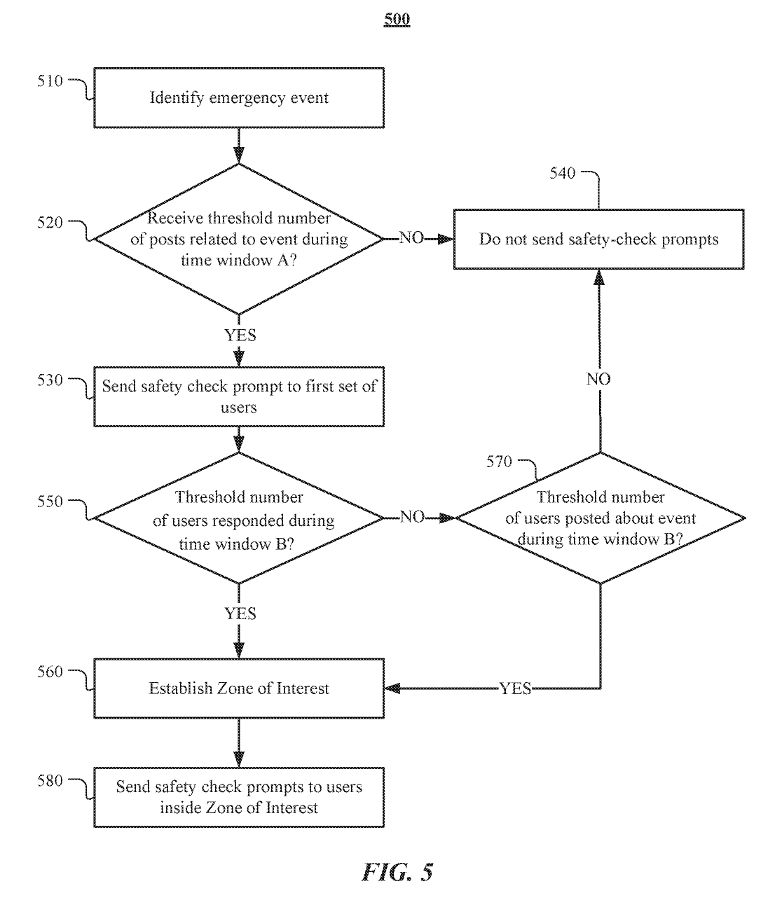

In particular embodiments, it may be unclear whether an emergency falls into one category or another category. As an example and not by way of limitation, an explosion may affect a relatively small amount of people (e.g., 500), and may be an isolated incident only lasting a few moments. However, the explosion may cause ongoing fear among users within the zone of interest, because they may be uncertain about whether another explosion will occur. Thus, the social-networking system may need to determine whether to extend the pre-determined amount of time based on whether the explosion should fall into quadrant 430 or quadrant 440. To make this determination, the social-networking system may analyze the severity of the emergency, the amount of user interaction related to the emergency, and the time with which the user interaction takes place. This is discussed in more detail with reference to FIG. 5 below.

In particular embodiments, the social-networking system may determine that a user has entered the geographic area with a pre-determined amount of time after the occurrence of the emergency event. In particular embodiments, the pre-determined amount of time may depend on the type of emergency event, as discussed above with reference to FIG. 4. As an example and not by way of limitation, the pre-determined amount of time for a shooting may be shorter than the pre-determined amount of time for a flood. In particular embodiments, determining that the user has entered the geographic area within the pre-determined amount of time after the occurrence of the emergency event comprises receiving location information from a software application open on and executing in a foreground of a mobile computing device of the user.

In particular embodiments, the social-networking system may send a safety-check prompt to the user to indicate whether the user is safe. The prompt may be a request for the user to indicate whether he or she is safe. As explained above with reference to FIGS. 1 and 2, the safety-check prompt may be sent as a notification on a lock screen or notification interface of the client system of the user. When the user receives the safety-check prompt notification, the user may interact with the notification by swiping or tapping on it or otherwise selecting it, or the user may ignore the notification. If the user interacts with the notification by opening it, a user interface may be displayed that provides information about the emergency event. As an example and not by way of limitation, an emergency panel may state that a tornado is currently affecting an area that the social-networking system is associating with the user, either because the GPS unit in the user's client device indicates that the user is located in the affected geographic area, or the user specified that she is currently living in the area affected by the emergency event. The emergency panel may include additional information, such as statistics or headlines related to the emergency event, as well as any directions safety officials wish to communicate to the public. As an example and not by way of limitation, text may be displayed that states “130 mph winds. Officials advise everyone to stay indoors.” A safety-check panel may comprise text and selectable icons whereby the user may designate his safety status. As an example and not by way of limitation, the safety-check panel may have text that states: “You appear to be in the area affected by Typhoon Ruby. Are you safe?”

In particular embodiments, the social-networking system may receive a response from the user indicating whether the user is safe. Selectable icons displayed in conjunction with the safety-check interface may allow the user to designate whether he or she is safe, not safe, or not in the area. If the user selects the “I'm not safe” icon, this information may be given to emergency personnel, who may then contact the user or send aid to the user. If the user selects the “I'm safe” icon, the social-networking system may display an option for the user to post a status update indicating this information, so that her friends and family know she is safe.

FIG. 5 illustrates an example method for determining a zone of interest and determining to send safety-check prompts to users within the zone of interest. The method may begin at step 510, where the social-networking system may identify an emergency event or otherwise determine that an emergency event has occurred, according to the embodiments described herein. At step 520, the social-networking system may determine if a threshold number of posts related to the emergency event have been received by the social-networking system during a first given time window (e.g., time window A, which may be any suitable length of time after the emergency is identified, such as 30 minutes). Posts related to the emergency event may be limited to posts that contain first-hand content, or they may also include posts that contain second-hand content (e.g., posts of news articles covering the event). The purpose of this step may be to determine whether there is sufficient user interest in the emergency event to warrant sending a safety-check prompt to a first set of users. As an alternative to a threshold number, the social-networking system may determine if a threshold percentage of users for a given region have posted content related to the emergency event to the online social network. Posting content may include sending information associated with the emergency event. Sending information associated with the emergency event may include sharing on the social-networking system an update associated with the emergency event. The information may be any suitable information, including text about the emergency, a photograph or video related to the emergency, a check-in at a location near the emergency, or any other suitable information. As an example and not by way of limitation, a sending information associated with the emergency event may be a status update that includes a video of a tree blowing in the wind during a hurricane, along with text that says, “The weather has been getting progressively worse for the past few hours.” Although this disclosure describes determining that a threshold number of posts related to the emergency event have been received in a particular manner, this disclosure contemplates determining that a threshold number of posts related to the emergency event have been received in any suitable manner.

If the threshold number or percentage of posts have been received by the social-networking system, the method may proceed to step 530. If not, the method may proceed to step 540, where no safety-check prompts are sent. In particular embodiments, step 520 may be omitted, and the social-networking system may simply move straight to step 530 from step 510. At step 530, the social-networking system may send a safety-check prompt to a first set of users. This step may have the purpose of gauging user interest with the safety-check prompt and with the emergency event. If a threshold number of users associated with the event have posted content (e.g., as done in step 520), the social-networking system may send a safety-check prompt to a first set of users as a “test batch.” This may be to gauge user-interest in the safety-check prompt. In particular embodiments, the first set of users may be selected at random from the group of users associated with the emergency who have already posted content related to the event. In particular embodiments, the first set of users need not have already posted content related to the event—the safety check prompt may be sent to a user regardless of whether she has previously posted content to the online social network. After sending the safety-check prompt to the first set of users, the social-networking system may then determine user engagement based on one or more engagement metrics. The engagement metrics may be those outlined in steps 550 and 570, as discussed below, or may be based on an individual user's social graph data (e.g., affinity to particular concepts, posting frequency), or on groups of users (e.g., the percentage of users who have responded or ignored the safety-check prompt). If user engagement is high enough (e.g., above a threshold level of engagement), the social-networking system may send the safety-check prompt to a second set of users that is larger than the first set of users. At one or more later points in time (e.g., at regular intervals or in real-time), the social-networking system may re-determine the user engagement, and determine to send the safety-check prompt to users at a steady rate, increased rate, or decreased rate, as well as update the zone of interest, based on the user engagement. This may be thought of as tiered-delivery of the safety-check prompt based on user engagement.

After sending the safety-check prompt to the first set of users, the social-networking system may, at step 550 determine whether a threshold number or percentage of users have responded to the safety-check prompt during a particular time window. The time window may be any suitable period of time after the safety-check prompt was sent during step 530. For example, time window B may be an hour after the safety check response was sent at step 530. In particular embodiments, the social-networking system may only determine the number or percentage of users who responded as being “unsafe.” In particular embodiments, the social-networking system may take into account all users who interact with the safety-check prompt, regardless of whether they marked themselves safe or unsafe. The reason for this may be that friends of users in the affected area may be interested to know whether their friends are safe or unsafe. Thus, if a threshold number of users respond to the safety-check prompt, this may satisfy the condition of step 550. In particular embodiments, the condition at step 550 may be satisfied if a threshold level of engagement is achieved. A threshold level of engagement may include a threshold number of users interacting with a previously sent safety check (e.g., the safety-check prompt sent at step 530), a threshold number of users ignoring or hiding a previously sent safety check, or a threshold number of impressions of a previously sent safety check (e.g., a threshold number of users have seen the safety-check prompt).

If the condition at step 550 is satisfied, the method may proceed to step 560, discussed below. If the condition at step 550 is not satisfied, the method may proceed to step 570. At step 570, the social-networking system may determine whether a threshold number of users have posted about the event during time window B. This step may be to determine if users are still engaging with the event even if they are not necessarily responding to the safety-check prompts. As an example and not by way of limitation, many users who receive the safety-check prompt may mark themselves as “safe” and then post that to the online social network. This may not satisfy the condition at step 550, but it may satisfy the condition at step 570 because marking oneself as safe and then posting that may qualify as posting about the event. If this action is performed within time window B, it may satisfy the condition at step 570, and the method may proceed to step 560.

At step 560, the social-networking system may establish a zone of interest for the emergency event. As discussed previously, the zone of interest may be a geographic area affected by the emergency event. The zone of interest may be established using any suitable method, including the methods discussed above with reference to FIG. 3. In particular embodiments, the zone of interest may be determined based on geography of the area surrounding the emergency event. The social-networking system may access map data provided by a third-party map provider. The map data may include any suitable information, including street dimensions, topographical information, the locations of rivers, lakes, and fields, or any other suitable information. The social-networking system may use this information to determine the zone of interest. As an example and not by way of limitation, if a wildfire in the east side of a town is determined to be an emergency event, the social-networking system may access map data and determine that a river separates the east side of the town from the west side of the town. The social-networking system may infer that the wildfire may not be able to jump the river and cross over into the west side of town. Thus, the social-networking system may determine the zone of interest to cover the east part of the town and not the west part of the town. As another example and not by way of limitation, a particular city may be at high flood risk. This may be determined to be an emergency event. The map data accessed by the social-networking system may include topographical information that indicates that certain streets in the city are elevated above the rest of the city by thirty feet. As it is unlikely that a flood will reach residents on those streets, the social-networking system may determine that the zone of interest excludes those streets. In particular embodiments, based on responses to safety prompts associated with the emergency event, the social-networking system may determine an update to the zone of interest. This may be done by analyzing locations associated with the client devices of users who have responded to the safety-check prompts. As an example and not by way of limitation, a user may receive a safety-check prompt and respond by marking himself as unsafe. The social-networking system may update the zone of interest based on this response using a similar process to that described with reference to FIG. 3 above.

At step 580, the social-networking system may send safety-check prompts to users who are inside the zone of interest. In particular embodiments, determining that a user is within the zone of interest means determining that a user has entered the geographic area within a pre-determined amount of time after the occurrence of the emergency event. This determination may be made by receiving location information from a software application open on and executing in a foreground of a mobile computing device of the user who is entering the zone of interest. As an example and not by way of limitation, a user may drive into an area impacted by an earthquake. The user may open an application associated with the online social network. This application may have location services enabled, and the social-networking system may retrieve the location of the user's device. In particular embodiments, a first user who is located within the zone of interest may receive a safety-check prompt that requests the first user to indicate whether she knows if a second user is safe. This type of safety-check prompt may be referred to as a friend-safety-check. A friend-safety-check prompt may prompt a user to indicate whether she knows if one of her friends is safe. This friend may be selected by the social-networking system because the friend may not have responded to a safety-check prompt sent directly to the friend. Although this disclosure describes sending a safety-check prompt in a particular manner, this disclosure contemplates sending a safety-check prompt in any suitable manner.

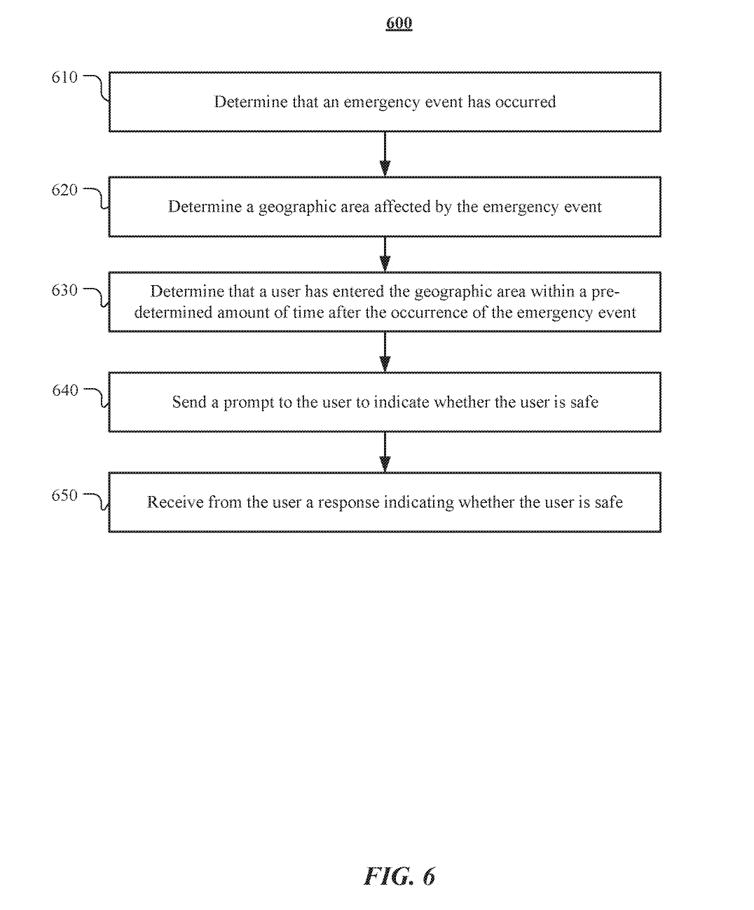

FIG. 6 illustrates an example method 600 for determining to send a safety-check prompt to a user. The method may begin at step 610, where the social-networking system may determine that an emergency event has occurred. At step 620, the social-networking system may determine a geographic area affected by the emergency event. At step 630, the social-networking system may determine that a user has entered the geographic area within a pre-determined amount of time after the occurrence of the emergency event. At step 640, the social-networking system may send a prompt to the user to indicate whether the user is safe. At step 650, the social-networking system may receive from the user a response indicating whether the user is safe. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for determining to send a safety-check prompt to a user including the particular steps of the method of FIG. 6, this disclosure contemplates any suitable method for determining to send a safety-check prompt to a user including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

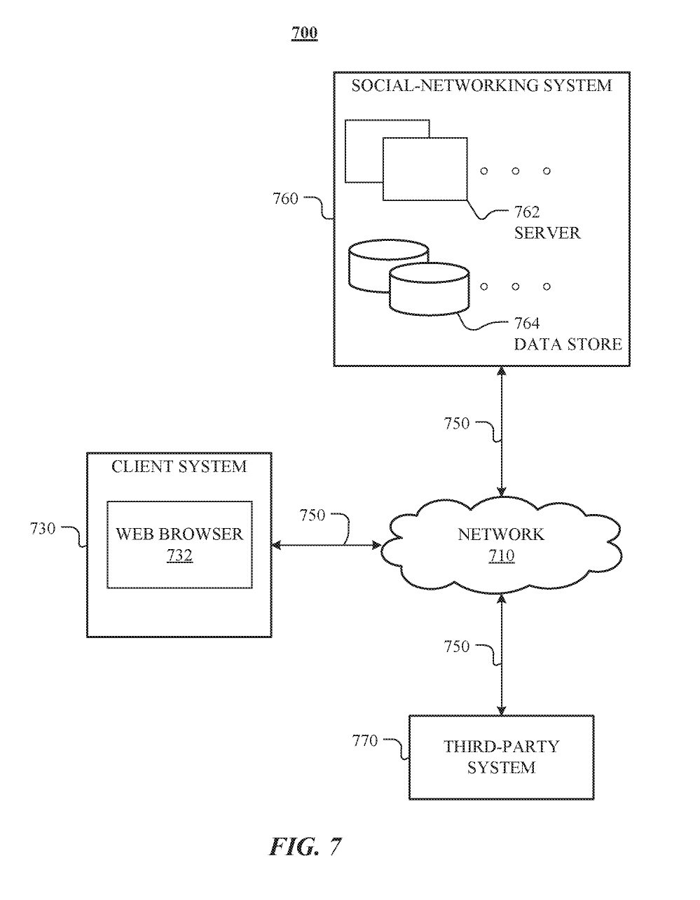

FIG. 7 illustrates an example network environment 700 associated with a social-networking system. Network environment 700 includes a client system 730, a social-networking system 760, and a third-party system 770 connected to each other by a network 710. Although FIG. 7 illustrates a particular arrangement of client system 730, social-networking system 760, third-party system 770, and network 710, this disclosure contemplates any suitable arrangement of client system 730, social-networking system 760, third-party system 770, and network 710. As an example and not by way of limitation, two or more of client system 730, social-networking system 760, and third-party system 770 may be connected to each other directly, bypassing network 710. As another example, two or more of client system 730, social-networking system 760, and third-party system 770 may be physically or logically co-located with each other in whole or in part. Moreover, although FIG. 7 illustrates a particular number of client systems 730, social-networking systems 760, third-party systems 770, and networks 710, this disclosure contemplates any suitable number of client systems 730, social-networking systems 760, third-party systems 770, and networks 710. As an example and not by way of limitation, network environment 700 may include multiple client system 730, social-networking systems 760, third-party systems 770, and networks 710.

This disclosure contemplates any suitable network 710. As an example and not by way of limitation, one or more portions of network 710 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 710 may include one or more networks 710.

Links 750 may connect client system 730, social-networking system 760, and third-party system 770 to communication network 710 or to each other. This disclosure contemplates any suitable links 750. In particular embodiments, one or more links 750 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 750 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 750, or a combination of two or more such links 750. Links 750 need not necessarily be the same throughout network environment 700. One or more first links 750 may differ in one or more respects from one or more second links 750.

In particular embodiments, client system 730 may be an electronic device including hardware, software, or embedded logic components or a combination of two or more such components and capable of carrying out the appropriate functionalities implemented or supported by client system 730. As an example and not by way of limitation, a client system 730 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 730. A client system 730 may enable a network user at client system 730 to access network 710. A client system 730 may enable its user to communicate with other users at other client systems 730.

In particular embodiments, client system 730 may include a web browser 732, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 730 may enter a Uniform Resource Locator (URL) or other address directing the web browser 732 to a particular server (such as server 762, or a server associated with a third-party system 770), and the web browser 732 may generate a Hyper Text Transfer Protocol (HTTP) request and communicate the HTTP request to server. The server may accept the HTTP request and communicate to client system 730 one or more Hyper Text Markup Language (HTML) files responsive to the HTTP request. Client system 730 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 760 may be a network-addressable computing system that can host an online social network. Social-networking system 760 may generate, store, receive, and send social-networking data, such as, for example, user-profile data, concept-profile data, social-graph information, or other suitable data related to the online social network. Social-networking system 760 may be accessed by the other components of network environment 700 either directly or via network 710. As an example and not by way of limitation, client system 730 may access social-networking system 760 using a web browser 732, or a native application associated with social-networking system 760 (e.g., a mobile social-networking application, a messaging application, another suitable application, or any combination thereof) either directly or via network 710. In particular embodiments, social-networking system 760 may include one or more servers 762. Each server 762 may be a unitary server or a distributed server spanning multiple computers or multiple datacenters. Servers 762 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 762 may include hardware, software, or embedded logic components or a combination of two or more such components for carrying out the appropriate functionalities implemented or supported by server 762. In particular embodiments, social-networking system 760 may include one or more data stores 764. Data stores 764 may be used to store various types of information. In particular embodiments, the information stored in data stores 764 may be organized according to specific data structures. In particular embodiments, each data store 764 may be a relational, columnar, correlation, or other suitable database. Although this disclosure describes or illustrates particular types of databases, this disclosure contemplates any suitable types of databases. Particular embodiments may provide interfaces that enable a client system 730, a social-networking system 760, or a third-party system 770 to manage, retrieve, modify, add, or delete, the information stored in data store 764.

In particular embodiments, social-networking system 760 may store one or more social graphs in one or more data stores 764. In particular embodiments, a social graph may include multiple nodes—which may include multiple user nodes (each corresponding to a particular user) or multiple concept nodes (each corresponding to a particular concept)—and multiple edges connecting the nodes. Social-networking system 760 may provide users of the online social network the ability to communicate and interact with other users. In particular embodiments, users may join the online social network via social-networking system 760 and then add connections (e.g., relationships) to a number of other users of social-networking system 760 to whom they want to be connected. Herein, the term “friend” may refer to any other user of social-networking system 760 with whom a user has formed a connection, association, or relationship via social-networking system 760.

In particular embodiments, social-networking system 760 may provide users with the ability to take actions on various types of items or objects, supported by social-networking system 760. As an example and not by way of limitation, the items and objects may include groups or social networks to which users of social-networking system 760 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 760 or by an external system of third-party system 770, which is separate from social-networking system 760 and coupled to social-networking system 760 via a network 710.

In particular embodiments, social-networking system 760 may be capable of linking a variety of entities. As an example and not by way of limitation, social-networking system 760 may enable users to interact with each other as well as receive content from third-party systems 770 or other entities, or to allow users to interact with these entities through an application programming interfaces (API) or other communication channels.

In particular embodiments, a third-party system 770 may include one or more types of servers, one or more data stores, one or more interfaces, including but not limited to APIs, one or more web services, one or more content sources, one or more networks, or any other suitable components, e.g., that servers may communicate with. A third-party system 770 may be operated by a different entity from an entity operating social-networking system 760. In particular embodiments, however, social-networking system 760 and third-party systems 770 may operate in conjunction with each other to provide social-networking services to users of social-networking system 760 or third-party systems 770. In this sense, social-networking system 760 may provide a platform, or backbone, which other systems, such as third-party systems 770, may use to provide social-networking services and functionality to users across the Internet.

In particular embodiments, a third-party system 770 may include a third-party content object provider. A third-party content object provider may include one or more sources of content objects, which may be communicated to a client system 730. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 760 also includes user-generated content objects, which may enhance a user's interactions with social-networking system 760. User-generated content may include anything a user can add, upload, send, or “post” to social-networking system 760. As an example and not by way of limitation, a user communicates posts to social-networking system 760 from a client system 730. Posts may include data such as status updates or other textual data, location information, photos, videos, links, music or other similar data or media. Content may also be added to social-networking system 760 by a third-party through a “communication channel,” such as a newsfeed or stream.

In particular embodiments, social-networking system 760 may include a variety of servers, sub-systems, programs, modules, logs, and data stores. In particular embodiments, social-networking system 760 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 760 may also include suitable components such as network interfaces, security mechanisms, load balancers, failover servers, management-and-network-operations consoles, other suitable components, or any suitable combination thereof. In particular embodiments, social-networking system 760 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 760 to one or more client systems 730 or one or more third-party system 770 via network 710. The web server may include a mail server or other messaging functionality for receiving and routing messages between social-networking system 760 and one or more client systems 730. An API-request server may allow a third-party system 770 to access information from social-networking system 760 by calling one or more APIs. An action logger may be used to receive communications from a web server about a user's actions on or off social-networking system 760. In conjunction with the action log, a third-party-content-object log may be maintained of user exposures to third-party-content objects. A notification controller may provide information regarding content objects to a client system 730. Information may be pushed to a client system 730 as notifications, or information may be pulled from client system 730 responsive to a request received from client system 730. Authorization servers may be used to enforce one or more privacy settings of the users of social-networking system 760. A privacy setting of a user determines how particular information associated with a user can be shared. The authorization server may allow users to opt in to or opt out of having their actions logged by social-networking system 760 or shared with other systems (e.g., third-party system 770), such as, for example, by setting appropriate privacy settings. Third-party-content-object stores may be used to store content objects received from third parties, such as a third-party system 770. Location stores may be used for storing location information received from client systems 730 associated with users. Advertisement-pricing modules may combine social information, the current time, location information, or other suitable information to provide relevant advertisements, in the form of notifications, to a user.

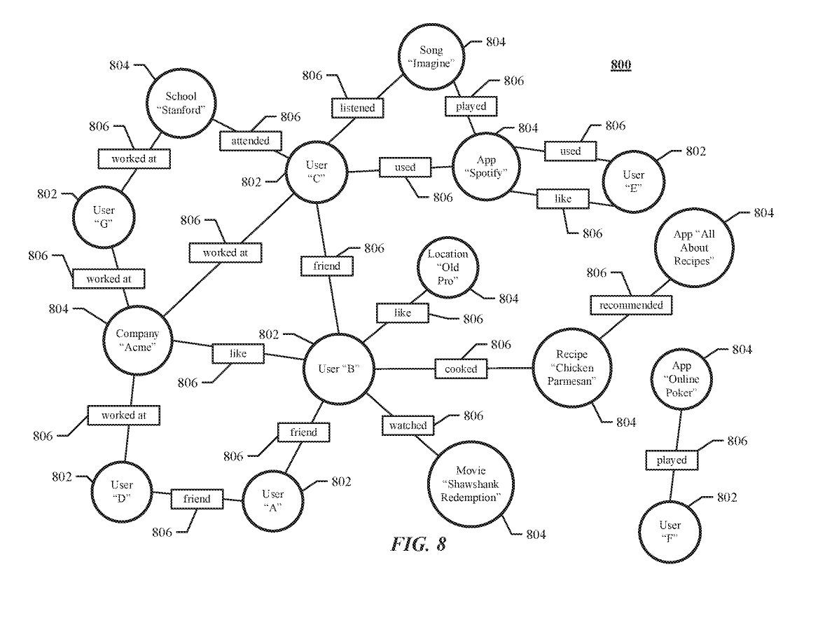

FIG. 8 illustrates example social graph 800. In particular embodiments, social-networking system 760 may store one or more social graphs 800 in one or more data stores. In particular embodiments, social graph 800 may include multiple nodes—which may include multiple user nodes 802 or multiple concept nodes 804—and multiple edges 806 connecting the nodes. Example social graph 800 illustrated in FIG. 8 is shown, for didactic purposes, in a two-dimensional visual map representation. In particular embodiments, a social-networking system 760, client system 730, or third-party system 770 may access social graph 800 and related social-graph information for suitable applications. The nodes and edges of social graph 800 may be stored as data objects, for example, in a data store (such as a social-graph database). Such a data store may include one or more searchable or queryable indexes of nodes or edges of social graph 800.

In particular embodiments, a user node 802 may correspond to a user of social-networking system 760. As an example and not by way of limitation, a user may be an individual (human user), an entity (e.g., an enterprise, business, or third-party application), or a group (e.g., of individuals or entities) that interacts or communicates with or over social-networking system 760. In particular embodiments, when a user registers for an account with social-networking system 760, social-networking system 760 may create a user node 802 corresponding to the user, and store the user node 802 in one or more data stores. Users and user nodes 802 described herein may, where appropriate, refer to registered users and user nodes 802 associated with registered users. In addition or as an alternative, users and user nodes 802 described herein may, where appropriate, refer to users that have not registered with social-networking system 760. In particular embodiments, a user node 802 may be associated with information provided by a user or information gathered by various systems, including social-networking system 760. As an example and not by way of limitation, a user may provide his or her name, profile picture, contact information, birth date, sex, marital status, family status, employment, education background, preferences, interests, or other demographic information. In particular embodiments, a user node 802 may be associated with one or more data objects corresponding to information associated with a user. In particular embodiments, a user node 802 may correspond to one or more webpages.

In particular embodiments, a concept node 804 may correspond to a concept. As an example and not by way of limitation, a concept may correspond to a place (such as, for example, a movie theater, restaurant, landmark, or city); a website (such as, for example, a website associated with social-network system 760 or a third-party website associated with a web-application server); an entity (such as, for example, a person, business, group, sports team, or celebrity); a resource (such as, for example, an audio file, video file, digital photo, text file, structured document, or application) which may be located within social-networking system 760 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 804 may be associated with information of a concept provided by a user or information gathered by various systems, including social-networking system 760. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 804 may be associated with one or more data objects corresponding to information associated with concept node 804. In particular embodiments, a concept node 804 may correspond to one or more webpages.

In particular embodiments, a node in social graph 800 may represent or be represented by a webpage (which may be referred to as a “profile page”). Profile pages may be hosted by or accessible to social-networking system 760. Profile pages may also be hosted on third-party websites associated with a third-party system 770. As an example and not by way of limitation, a profile page corresponding to a particular external webpage may be the particular external webpage and the profile page may correspond to a particular concept node 804. Profile pages may be viewable by all or a selected subset of other users. As an example and not by way of limitation, a user node 802 may have a corresponding user-profile page in which the corresponding user may add content, make declarations, or otherwise express himself or herself. As another example and not by way of limitation, a concept node 804 may have a corresponding concept-profile page in which one or more users may add content, make declarations, or express themselves, particularly in relation to the concept corresponding to concept node 804.

In particular embodiments, a concept node 804 may represent a third-party webpage or resource hosted by a third-party system 770. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 730 to send to social-networking system 760 a message indicating the user's action. In response to the message, social-networking system 760 may create an edge (e.g., a check-in-type edge) between a user node 802 corresponding to the user and a concept node 804 corresponding to the third-party webpage or resource and store edge 806 in one or more data stores.

In particular embodiments, a pair of nodes in social graph 800 may be connected to each other by one or more edges 806. An edge 806 connecting a pair of nodes may represent a relationship between the pair of nodes. In particular embodiments, an edge 806 may include or represent one or more data objects or attributes corresponding to the relationship between a pair of nodes. As an example and not by way of limitation, a first user may indicate that a second user is a “friend” of the first user. In response to this indication, social-networking system 760 may send a “friend request” to the second user. If the second user confirms the “friend request,” social-networking system 760 may create an edge 806 connecting the first user's user node 802 to the second user's user node 802 in social graph 800 and store edge 806 as social-graph information in one or more of data stores 764. In the example of FIG. 8, social graph 800 includes an edge 806 indicating a friend relation between user nodes 802 of user “A” and user “B” and an edge indicating a friend relation between user nodes 802 of user “C” and user “B.” Although this disclosure describes or illustrates particular edges 806 with particular attributes connecting particular user nodes 802, this disclosure contemplates any suitable edges 806 with any suitable attributes connecting user nodes 802. As an example and not by way of limitation, an edge 806 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 800 by one or more edges 806. The degree of separation between two objects represented by two nodes, respectively, is a count of edges in a shortest path connecting the two nodes in the social graph 800. As an example and not by way of limitation, in the social graph 800, the user node 802 of user “C” is connected to the user node 802 of user “A” via multiple paths including, for example, a first path directly passing through the user node 802 of user “B,” a second path passing through the concept node 804 of company “Acme” and the user node 802 of user “D,” and a third path passing through the user nodes 802 and concept nodes 804 representing school “Stanford,” user “G,” company “Acme,” and user “D.” User “C” and user “A” have a degree of separation of two because the shortest path connecting their corresponding nodes (i.e., the first path) includes two edges 806.

In particular embodiments, an edge 806 between a user node 802 and a concept node 804 may represent a particular action or activity performed by a user associated with user node 802 toward a concept associated with a concept node 804. As an example and not by way of limitation, as illustrated in FIG. 8, a user may “like,” “attended,” “played,” “listened,” “cooked,” “worked at,” or “watched” a concept, each of which may correspond to an edge type or subtype. A concept-profile page corresponding to a concept node 804 may include, for example, a selectable “check in” icon (such as, for example, a clickable “check in” icon) or a selectable “add to favorites” icon. Similarly, after a user clicks these icons, social-networking system 760 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 760 may create a “listened” edge 806 and a “used” edge (as illustrated in FIG. 8) between user nodes 802 corresponding to the user and concept nodes 804 corresponding to the song and application to indicate that the user listened to the song and used the application. Moreover, social-networking system 760 may create a “played” edge 806 (as illustrated in FIG. 8) between concept nodes 804 corresponding to the song and the application to indicate that the particular song was played by the particular application. In this case, “played” edge 806 corresponds to an action performed by an external application (SPOTIFY) on an external audio file (the song “Imagine”). Although this disclosure describes particular edges 806 with particular attributes connecting user nodes 802 and concept nodes 804, this disclosure contemplates any suitable edges 806 with any suitable attributes connecting user nodes 802 and concept nodes 804. Moreover, although this disclosure describes edges between a user node 802 and a concept node 804 representing a single relationship, this disclosure contemplates edges between a user node 802 and a concept node 804 representing one or more relationships. As an example and not by way of limitation, an edge 806 may represent both that a user likes and has used at a particular concept. Alternatively, another edge 806 may represent each type of relationship (or multiples of a single relationship) between a user node 802 and a concept node 804 (as illustrated in FIG. 8 between user node 802 for user “E” and concept node 804 for “SPOTIFY”).

In particular embodiments, social-networking system 760 may create an edge 806 between a user node 802 and a concept node 804 in social graph 800. As an example and not by way of limitation, a user viewing a concept-profile page (such as, for example, by using a web browser or a special-purpose application hosted by the user's client system 730) may indicate that he or she likes the concept represented by the concept node 804 by clicking or selecting a “Like” icon, which may cause the user's client system 730 to send to social-networking system 760 a message indicating the user's liking of the concept associated with the concept-profile page. In response to the message, social-networking system 760 may create an edge 806 between user node 802 associated with the user and concept node 804, as illustrated by “like” edge 806 between the user and concept node 804. In particular embodiments, social-networking system 760 may store an edge 806 in one or more data stores. In particular embodiments, an edge 806 may be automatically formed by social-networking system 760 in response to a particular user action. As an example and not by way of limitation, if a first user uploads a picture, watches a movie, or listens to a song, an edge 806 may be formed between user node 802 corresponding to the first user and concept nodes 804 corresponding to those concepts. Although this disclosure describes forming particular edges 806 in particular manners, this disclosure contemplates forming any suitable edges 806 in any suitable manner.

In particular embodiments, social-networking system 760 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 770 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 760 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 760 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 760 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 760 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 760 may calculate a coefficient based on a user's actions. Social-networking system 760 may monitor such actions on the online social network, on a third-party system 770, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 760 may calculate a coefficient based on the user's actions with particular types of content. The content may be associated with the online social network, a third-party system 770, or another suitable system. The content may include users, profile pages, posts, news stories, headlines, instant messages, chat room conversations, emails, advertisements, pictures, video, music, other suitable objects, or any combination thereof. Social-networking system 760 may analyze a user's actions to determine whether one or more of the actions indicate an affinity for subject matter, content, other users, and so forth. As an example and not by way of limitation, if a user frequently posts content related to “coffee” or variants thereof, social-networking system 760 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 760 may calculate a coefficient based on the type of relationship between particular objects. Referencing the social graph 800, social-networking system 760 may analyze the number and/or type of edges 806 connecting particular user nodes 802 and concept nodes 804 when calculating a coefficient. As an example and not by way of limitation, user nodes 802 that are connected by a spouse-type edge (representing that the two users are married) may be assigned a higher coefficient than a user nodes 802 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 760 may determine that the user has a higher coefficient with respect to the first photo than the second photo because having a tagged-in-type relationship with content may be assigned a higher weight and/or rating than having a like-type relationship with content. In particular embodiments, social-networking system 760 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 760 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 800. As an example and not by way of limitation, social-graph entities that are closer in the social graph 800 (i.e., fewer degrees of separation) may have a higher coefficient than entities that are further apart in the social graph 800.

In particular embodiments, social-networking system 760 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 730 of the user). A first user may be more interested in other users or concepts that are closer to the first user. As an example and not by way of limitation, if a user is one mile from an airport and two miles from a gas station, social-networking system 760 may determine that the user has a higher coefficient for the airport than the gas station based on the proximity of the airport to the user.

In particular embodiments, social-networking system 760 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 760 may provide information that is relevant to user's interests and current circumstances, increasing the likelihood that they will find such information of interest. In particular embodiments, social-networking system 760 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 760 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 760 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 770 (e.g., via an API or other communication channel), or from another suitable system. In response to the request, social-networking system 760 may calculate the coefficient (or access the coefficient information if it has previously been calculated and stored). In particular embodiments, social-networking system 760 may measure an affinity with respect to a particular process. Different processes (both internal and external to the online social network) may request a coefficient for a particular object or set of objects. Social-networking system 760 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632869, filed 1 Oct. 2012, each of which is incorporated by reference.

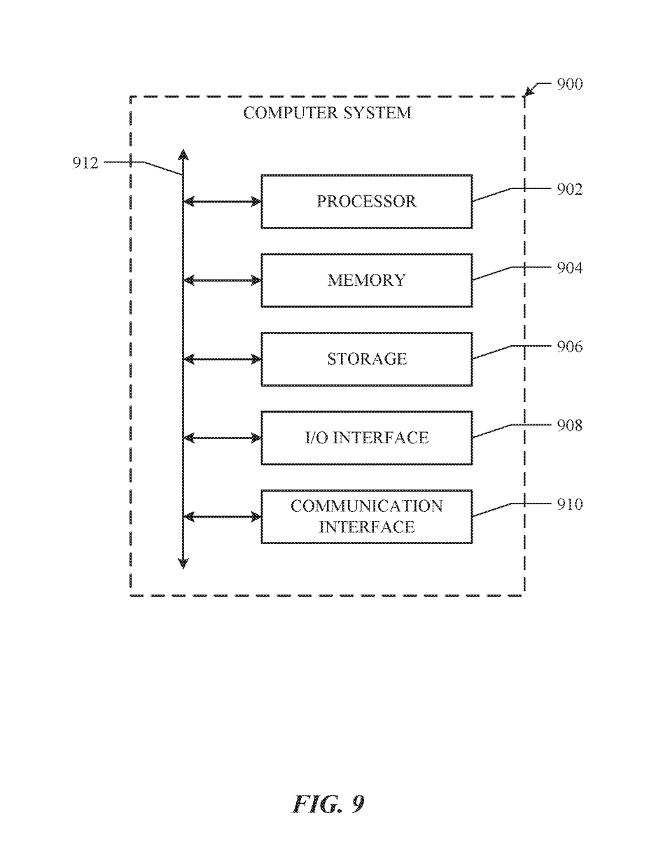

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising, by one or more computing devices:
determining that an emergency event has occurred;
determining a geographic area affected by the emergency event;
determining that a user has entered the geographic area within a pre-determined amount of time after the occurrence of the emergency event;
sending a prompt to the user to indicate whether the user is safe; and
receiving from the user a response indicating whether the user is safe.

2. The method of claim 1, wherein determining that the user has entered the geographic area within the pre-determined amount of time after the occurrence of the emergency event comprises receiving location information from a software application open on and executing in a foreground of a mobile computing device of the user.

3. The method of claim 1, wherein the prompt is sent if at least a pre-determined threshold number of users send information associated with the emergency event.

4. The method of claim 3, wherein sending information associated with the emergency event comprises sharing on a social-networking system an update associated with the emergency event.

5. The method of claim 3, wherein the information is a check-in, text, video, or photograph.

6. The method of claim 1, wherein the user is a user of a social-networking system.

7. The method of claim 1, wherein the prompt is sent to the user only if at least a predetermined threshold percentage of users in the geographic area or within a predetermined distance of the geographic area have posted content related to the emergency event.

8. The method of claim 1, wherein the prompt is sent to the user only if there was at least a predetermined threshold level of engagement by users with a previous safety check associated with the emergency event.

9. The method of claim 8, wherein the predetermined threshold level of engagement with the previous safety check comprises:
a predetermined number of users interacting with the previous safety check;
a predetermined number of users ignoring or hiding the previous safety check; or
a predetermined number of impressions of the previous safety check.

10. The method of claim 1, further comprising, based on responses to safety prompts associated with the emergency event, determining an update to the geographic area affected by the emergency event.

11. The method of claim 1, further comprising:
at a time associated with the emergency event, determining that a second user is currently in the geographic area;
sending a prompt to the second user to indicate whether the user is safe; and
receiving from the second user a response indicating whether the user is safe.

12. One or more computer-readable non-transitory storage media embodying software that is operable when executed to:
determine that an emergency event has occurred;
determine a geographic area affected by the emergency event;
determine that a user has entered the geographic area within a pre-determined amount of time after the occurrence of the emergency event;
send a prompt to the user to indicate whether the user is safe; and
receive from the user a response indicating whether the user is safe.

13. The media of claim 12, wherein determining that the user has entered the geographic area within the pre-determined amount of time after the occurrence of the emergency event comprises receiving location information from a software application open on and executing in a foreground of a mobile computing device of the user.

14. The media of claim 12, wherein the prompt is sent if at least a pre-determined threshold number of users send information associated with the emergency event.

15. The media of claim 14, wherein sending information associated with the emergency event comprises sharing on a social-networking system an update associated with the emergency event.

16. The media of claim 14, wherein the information is a check-in, text, video, or photograph.

17. A system comprising:
one or more processors; and
one or more computer-readable non-transitory storage media coupled to one or more of the processors and comprising instructions operable when executed by one or more of the processors to cause the system to:
determine that an emergency event has occurred;
determine a geographic area affected by the emergency event;
determine that a user has entered the geographic area within a pre-determined amount of time after the occurrence of the emergency event;
send a prompt to the user to indicate whether the user is safe; and
receive from the user a response indicating whether the user is safe.

18. The system of claim 17, wherein determining that the user has entered the geographic area within the pre-determined amount of time after the occurrence of the emergency event comprises receiving location information from a software application open on and executing in a foreground of a mobile computing device of the user.

19. The system of claim 17, wherein the prompt is sent if at least a pre-determined threshold number of users send information associated with the emergency event.

20. The system of claim 19, wherein sending information associated with the emergency event comprises sharing on a social-networking system an update associated with the emergency event.
